(19) United States
(12) Patent Application Publication
(10) Pub. No.: US 2023/0400155 A1
(43) Pub. Date: Dec. 14, 2023

(54) MEASURING SYSTEM FOR DETERMINING A DISPENSED AMOUNT OF HYDROGEN AND METHOD THEREFOR

(71) Applicants: ITS Ingenieurbüro T. Steuer, Dachau (DE); TrigasDM GmbH, Neufahrn (DE)

(72) Inventors: Jessica MANDT, Neufahrn (DE); Christian STÖCKLE, Neufahrn (DE); Thomas STEUER, Dachau (DE)

(73) Assignees: ITS Ingenieurbüro T. Steuer, Dachau (DE); TrigasDM GmbH, Neufahrn (DE)

(21) Appl. No.: 18/033,959

(22) PCT Filed: Nov. 18, 2021
(86) PCT No.: PCT/EP2021/082128

§ 371 Date: Apr. 26, 2023

(30) Foreign Application Priority Data
Dec. 2, 2020 (EP) 20211219.9

(51) Int. Cl. F17C 13/02; G01F 25/10; F17C 5/06

(52) U.S. Cl. CPC F17C 13/028; G01F 25/15; F17C 5/06; F17C 2221/012; F17C 2265/065; F17C 2270/0139; F17C 2250/0443

(57) ABSTRACT

The invention relates to a measuring system for determining a dispensed amount of hydrogen of a hydrogen dispensing location from a hydrogen dispensing unit present there to a receiving tank including a measuring unit. The measuring unit can have a flowmeter, wherein the measuring system is designed to establish a fluid-tight connection between the hydrogen dispensing unit and the receiving tank. Furthermore, the flowmeter has an active cooling. The invention further relates to a measuring method for determining a dispensed amount of hydrogen.

The invention relates to a measuring system for determining a dispensed amount of hydrogen of a hydrogen dispensing location from a hydrogen dispensing unit present there to a receiving tank. For this purpose, a measuring unit is provided in the measuring system.

The hydrogen dispensing location can, for example, be a hydrogen fueling station, in which case the hydrogen dispensing unit is the corresponding filling point or pump.

The invention further relates to a method for determining the dispensed amount of hydrogen of a hydrogen dispensing location, in particular a hydrogen fueling station, with a hydrogen dispensing unit to a receiving tank.

In addition to the electrification of vehicles the use of hydrogen as energy supply represents another possibility to realize mobility in a more environmentally friendly way. Compared to the use of electricity the use of hydrogen currently has the advantage that the fueling processes can be carried out at a significantly faster rate as compared to the charging of a battery and the ranges of the fuel cell vehicles are considerably larger than those of pure battery electric vehicles. Moreover, there is no problem with the disposal of the batteries that are often highly toxic.

However, a network of hydrogen fueling stations does as yet not exist or rather is not yet present in sufficient density. When operating and constructing a hydrogen fueling station various national requirements must be observed. For example, in Germany the law on measures and calibration requires verification as to whether the dispensed amount indicated at the fueling station, i.e. the refueled and therefore dispensed amount of hydrogen, corresponds to the amount actually dispensed.

Common fueling processes are carried out at various pressure ranges from approximately 20 bar to approximately 700 bar. Pressures of such height are provided to carry out the fueling process in the most rapid way possible so that fueling times similar to those of liquid fuels, such as gasoline or diesel, can be achieved.

However, the consequence of this is that the hydrogen introduced into a tank heats up when being compressed. For constructional reasons such tanks are only to be subjected to a maximum of 90° C. To avoid unnecessary premature termination of the fueling process and for rapid refueling the hydrogen is cooled so that it has a temperature ranging between −20° C. and up to −40° C.

For the necessary calibration processes gravimetrical systems are essentially known at present.

In this case, a receiving tank is mounted on a trailer and has an integrated high-precision scale. This tank is refueled by means of the hydrogen dispensing unit. Subsequently, the weight increase which lies in the range of 1 kg to 4 kg is established with high precision. This variable is compared to the measured variable indicated by the fueling station in order to thereby carry out a calibration.

The problem with these systems, however, is that they are extremely sensitive and prone to errors. The tank with set-up mostly has a weight of approximately 400 kg, with only a fraction of the weight being added by refueling—1 kg to 4 kg of hydrogen. Due to the necessary high-precision resolution of the scale, however, the trailer on which the tank is located is highly susceptible to environmental influences. Even the pressure load of the wind acting on the trailer is already visible on the scale. Ideally, the measurement can therefore only be carried out under good weather conditions and during the summer months.

Another problem can be seen in the emptying of the tank. In order to carry out reliable measurements the law on measures and calibration requires that at least three continuous measurements are submitted. However, the tank can only be emptied at a relatively slow rate since a rapid expansion of the hydrogen might otherwise cause damage to the tank and give rise to defects in its structure. Moreover, the expanding hydrogen cools down significantly during blow-off so that condensate develops on the tank. The condensate, in turn, leads to considerable measurement deviations.

In addition, the discharged hydrogen is at present blown into the environment without being utilized. For this purpose, a stack has to be specifically set up at a distance of at least 20 meters from the fueling station to ensure safe blow-off of the hydrogen.

The consequence of all this is that a corresponding calibration campaign takes 3 to 4 days and for this time the fueling station is blocked. In this respect it must be taken into consideration that such a calibration is to be carried out every 1 to 2 years.

The basic design of hydrogen refueling stations is known, for example, from DE 11 2011 101 417 T5, US 2017/254479 A1, US 2015/267865 A1, WO 2019/230651 A1.

The invention is therefore based on the object to provide an efficient measuring system and measuring method, with which the amount of hydrogen dispensed from a hydrogen dispensing unit to a receiving tank is measured.

In accordance with the invention this object is achieved by a system having the features of claim 1 and by a measuring method having the features of claim 13.

Further advantageous embodiments are stated in the dependent claims, the description as well as in the Figures and their description.

According to the invention provision is made in that the measuring unit has a flowmeter which can be arranged between the hydrogen dispensing unit and the receiving tank. Furthermore, the measuring system is designed to establish a fluid-tight connection between the hydrogen dispensing unit and the receiving tank and lead the hydrogen dispensed by the hydrogen dispensing unit through the flowmeter to the receiving tank. Moreover, provision is made in that the flowmeter has an active cooling.

A fundamental idea of the invention can be seen in the fact that by way of appropriate further means it is possible to determine the dispensed amount of hydrogen with a flowmeter in a highly precise manner. In conjunction with this it must be taken into consideration that before dispensing the flowmeter is mostly at room temperature or rather ambient temperature. This means that temperatures can amount to between +5° C. and +40° C. As already set out, the gaseous highly compressed hydrogen has a temperature of up to −40° C. As a result, when carrying out measurements with the required high-precision flowmeters a high zero drift would be present so that the precision of the measurement required by the law on measures and calibration could not be reached.

According to the invention, however, the realization was made that this problem can be avoided if the flowmeter is actively cooled. In other words, an active cooling is provided that already cools the flowmeter to temperatures in the range between −30° C. and −50° C. before a measurement so that when the highly compressed and cooled hydrogen is led through no change or substantially no change of temperature occurs any more in the flowmeter.

By means of the invention it is therefore possible to carry out a measuring campaign in a considerably shorter time and relatively independent of ambient temperatures.

According to the invention it is preferential if the active cooling is provided as an external cooling of the flowmeter. In particular, this can also mean that the active cooling is not part of the flowmeter itself but can be added as a further component or unit.

Basically, various possibilities of active cooling are conceivable. For example, a Peltier element or also a classical compressor cooling can be used for this. However, it is preferential if the active cooling is carried out by means of an external cooling material. For this purpose, dry ice is particularly suitable.

A hydrogen fueling station is considered as an explosion hazard zone and classified as Ex-Zone 1. This means that all equipment present there has to be of corresponding explosion-protected design. This shows the particular advantage of an external cooling material, in particular energy-supply-free, which can be dry ice for example.

Dry ice is not inflammable and has a temperature of approximately −78° C. Generally, it can be procured at a reasonable price and, apart from the cold temperatures, is also easy to handle. Hence, there are no problems with regard to the Ex-Zone or the required explosion protection. Dry ice is solid carbon dioxide (CO₂). It also has the advantage that at ambient temperature it is gaseous, hence evaporates. Generally, other cold stores are suitable too.

Preferably, a receiving device with thermal contact to the flowmeter is designed in the measuring unit. In this way, it is possible to introduce the external cooling material into the receiving device and cool the flowmeter in the most efficient and simplest way possible. The receiving device can be of trough-like design for example.

To this end the receiving device can, for example, be designed as a hollow space accessible from the outside. This can be realized in the form of a simple compartment that has a corresponding flap so that it is accessible. Through a lock of the flap ensurance can be made that when a measurement is being carried out environmental influences impacting via this compartment onto the flowmeter are as little as possible.

The thermal coupling between the receiving device and the flowmeter can be realized in various ways. One possibility is to design a wall of the receiving device by way of a part of the body of the flowmeter. It is expedient for the housing or the body of the flowmeter to be made of stainless steel in solid design so that a good heat transfer takes place and the flowmeter is cooled well.

Although a greater mass of this housing or body of the flowmeter necessitates longer and more intensive cooling this offers the advantage that temperature variations occur less strongly in the process of measurement.

As flowmeter different flowmeters can be used. Exemplary for this is a Coriolis flowmeter, an ultrasonic flowmeter or a flowmeter using critical nozzles. As a matter of course, other types of flowmeters suitable for measuring fluids, especially gases, can also be used.

It is advantageous if a connection for transmitting bidirectional infrared signals between the hydrogen dispensing unit and the receiving tank is provided. In this case, the connection can be guided as a bypass around the measuring unit but can also be guided through the measuring unit itself.

In hydrogen fueling stations customary in Europe provision is made parallelly inside or on the fuel hose for connecting means for an infrared connection between the hydrogen dispensing unit, i.e. the filling pump, and the receiving tank, for example in a car. The dispenser may be provided, for example, at a hydrogen filling station or hydrogen filling system, which may be stationary or mobile. This infrared connection which is cable-based in most cases serves for the bidirectional communication between the hydrogen dispensing unit and the receiving tank. As will be explained in more detail hereinafter, through this the fueling parameters are mediated and the fueling process is controlled. However, the connection can also be wireless.

By providing the bidirectional infrared connection during the measuring process safe refueling can be rendered possible. One possibility is to guide the connection for the bidirectional infrared signals past the measuring unit. In other words, the fuel hose can be connected from the filling pump to the measuring unit, with the cable-based infrared connection being led separately by way of another cable past the measuring unit directly to the receiving tank that can be located in a motor vehicle. From the measuring unit, on the other hand, a connection to the tank is established with a second fuel hose. In this way, the infrared signals can be transmitted between the receiving tank and the hydrogen dispensing unit as well as the hydrogen being transferred into the receiving tank.

In another embodiment the infrared signal connection can be guided through the measuring unit. To this end, the fuel hose of the hydrogen dispensing unit is directly connected to the measuring unit. This, in turn, passes the infrared signals on. For this, a suitable fuel hose can be connected between the measuring unit and the receiving tank, via which both the hydrogen can be refueled and the infrared signals can be passed on. As a matter of course, solutions are also possible, in which the infrared signals are transmitted by means of an interposed radio connection.

Advantageously, the measuring unit of the measuring system has the flowmeter and a control and evaluation unit. The control and evaluation unit substantially serves for control and evaluation of the data of the flowmeter. This allows for a short line connection, whereby the high-precision measurement is enhanced further.

In addition, a separate display unit can be provided which has at least a data logger and a measurement display. The display unit can be in communication connection with the measuring unit. Basically, it is also possible for the display unit and the measuring unit to be of integrated design.

The measurement display provided in the display unit serves to output the measured results. To create adequate conditions in compliance with the law on measures and calibration the data logger can additionally be provided that logs all data.

Moreover, it is also possible to provide further evaluation electronics in the display unit, such as a data interface to download the data from the data logger or also means for radio-based data transmission to a higher-level location.

Furthermore, the invention relates to a method for determining the dispensed amount of hydrogen of a hydrogen dispensing location, in particular a hydrogen fueling station, with a hydrogen dispensing unit to a receiving tank. According to the invention provision is made in that the previously described measuring system is used. To carry out the method a fluid-tight connection is established between the hydrogen dispensing unit and the measuring unit as well as between the measuring unit and the receiving tank. For this purpose, the regular dispensing hose or rather the fuel hose of the hydrogen dispensing unit can be connected to the measuring unit that has a corresponding interface or coupling.

Additionally, a fuel hose of similar design is connected from the measuring system to the receiving tank. Inside the measuring unit a fluid-tight connection is also provided from the connector for the hydrogen dispensing unit to the connector for the receiving tank.

Subsequently, hydrogen is transferred via the fluid-tight connection from the hydrogen dispensing unit via the flowmeter of the measuring system to the receiving tank. In this process, the flowmeter of the measuring system is arranged in the connection between the connector for the hydrogen dispensing unit and the receiving tank.

Within the meaning of the invention a fluid can be both a gas and a liquid, although in the following the example of hydrogen as gas is explained in greater detail.

During throughflow of the hydrogen through the flowmeter when the hydrogen is being dispensed from the hydrogen dispensing unit to the receiving tank, the amount flowing through the flowmeter is determined. To eliminate the previously described temperature drift and the concomitant precision problems the flowmeter is actively cooled before the beginning of the transfer of the hydrogen from the hydrogen dispensing unit to the receiving tank. Within the framework of the invention before the beginning of the transfer means that the cooling is begun in good time such that the flowmeter is at its operating temperature before the fueling process is begun.

It is advantageous if the flowmeter is cooled with a cooling material, in particular dry ice, introduced into the receiving space. As already set out, dry ice offers itself as a relatively cost-efficient and easy-to-handle material which can also be used without any problem in explosion-protected areas.

The invention was described here with regard to hydrogen in particular. However, it can also be employed for the high-precision determination of a dispensed amount of any other fluid, in particular when being transferred in a cooled manner.

The invention is explained in greater detail hereinafter by way of an exemplary embodiment as well as schematic drawings, wherein show:

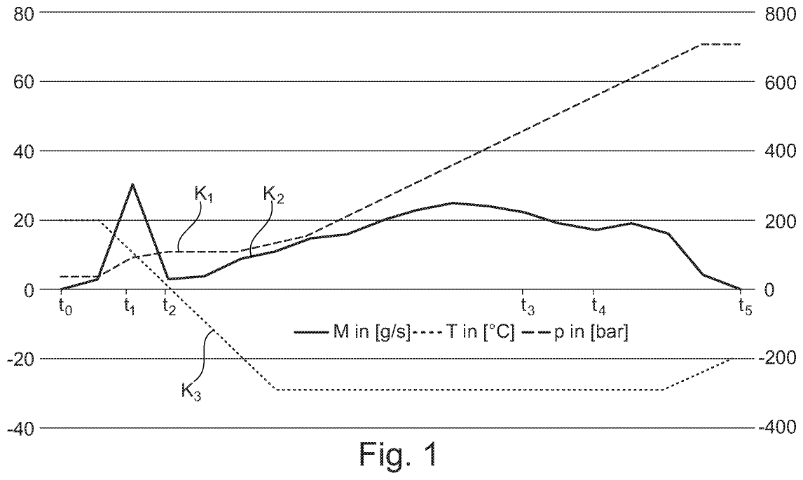

FIG. 1 a diagram to explain a typical filling process at a hydrogen fueling station; and

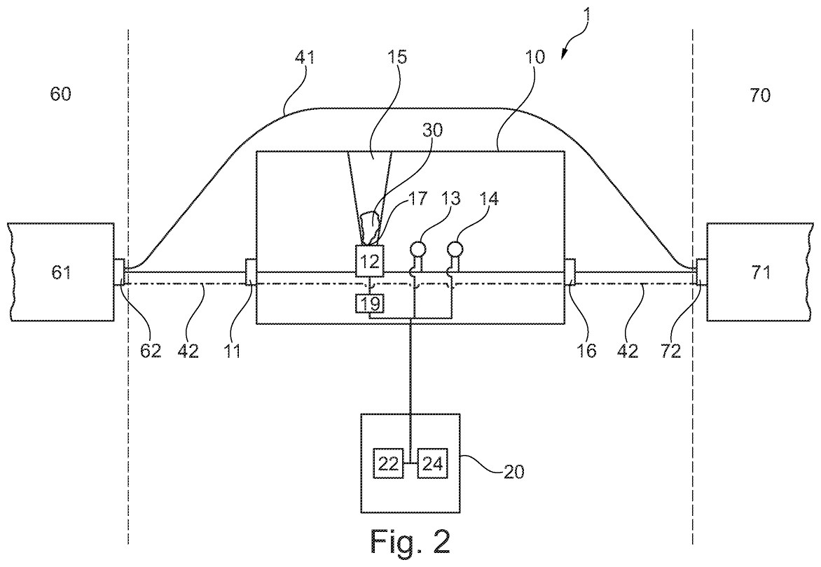

FIG. 2 a simplified illustration of the measuring system according to the invention.

In FIG. 1 a diagram to explain the standard filling process at a hydrogen fueling station is illustrated.

In this, three different curves K₁, K₂ and K₃ are shown over time. Curve K₁ relates to the pressure prevailing in or on the receiving tank. K₂ shows the mass flow through a connecting hose between the dispensing location and the receiving tank. K₃ illustrates the temperature in the fuel hose during the fueling process.

In FIG. 1 the time during the fueling process is plotted on the abscissa. On the left ordinate the mass flow is shown in g/s for curve K₃. Illustrated with the same resolution on the right ordinate is the pressure in bar for curve K₁ and the temperature in ° C. for curve K₃.

In the following the fueling process is explained in principle. At time to the fuel hose is connected between the hydrogen dispensing unit, i.e. the filling pump and the receiving tank. At time t₁ a high pressure pulse is introduced via the system of the fueling station into the closed hose system, which, however, is of short duration only. Subsequently, a test is made as to whether the pressure can be maintained or not. This serves to ensure and verify whether the connection is fluid-tight. Afterwards, at time t₂ refueling is begun.

As a standard, hydrogen fueling stations in Europe have three different tanks: a low-pressure tank up to approximately 200 bar, a medium-pressure tank up to approximately 600 bar and a high-pressure tank with a filling between 700 bar and 800 bar. At time t₃ determination is made by the fueling station that the filling from the low-pressure tank, with which the process was initially begun, no longer takes place at a sufficiently fast rate and a switchover to the medium-pressure tank is effected. At time t₄ the same determination takes place for the medium-pressure tank so that a switchover to the high-pressure tank is implemented. At time t₅ the fueling process is completed since the maximum permissible pressure is present in the tank of the vehicle. Other embodiments of hydrogen fueling stations use cryogenic liquid hydrogen which, by being vaporized and compressed, is used in a similar process as highly compressed hydrogen for vehicle refueling.

By means of the measuring system according to the invention which is explained in greater detail hereinafter and illustrated schematically in FIG. 2 the mass flow during the fueling process can be determined with high precision.

In FIG. 2, on the left side a hydrogen dispensing location 60, for example in the form of a fueling station, is initially provided. This has a hydrogen dispensing unit 61, on which a connector piece 62 is provided. On the right side of the Figure a motor vehicle 70 is illustrated, in which a receiving tank 71 is arranged which, in turn, has a connector piece 72.

In normal operation a direct fluid-tight connection would be established with a dispensing hose between the hydrogen dispensing location 61 or rather the connector piece 62 and the receiving tank 71 or rather its connector piece 72. However, in order that a calibration of the amount of hydrogen dispensed by the hydrogen dispensing unit 61 or an additional verification is provided a measuring system 1 according to the invention is interposed.

The measuring system 1 according to the invention consists of two main components. On the one hand this is a measuring unit 10 and on the other hand a display unit 20.

In the measuring unit 10 a flowmeter 12 is provided that has a corresponding control and evaluation unit 19. Furthermore, two connector pieces 11, 16 are provided. Between the two connector pieces 11, 16 a fluid-tight connection is provided that is guided through the flowmeter 12. On this connection a temperature sensor 13 and a pressure sensor 14 are additionally arranged. In the exemplary embodiment the display unit 20 has a data logger 22 as well as a measurement display 24. Both the data logger 22 and the measurement display 24 are in communication connection with the control and evaluation unit 19 as well as the temperature sensor 13 and the pressure sensor 14. These connections are only outlined in FIG. 1.

To carry out a measurement of the dispensed amount, according to the invention a fluid-tight connection is established between the hydrogen dispensing unit 61 or rather its connector 62 and the connector piece 11 of the measuring unit 10 as well as the connector piece 16 of the measuring unit 10 and the connector piece 72 of the receiving tank 71. Now hydrogen can flow via the hydrogen dispensing unit 61 into the receiving tank 71. For this, the method previously described with reference to FIG. 1 is applied.

Due to the fact that the hydrogen is highly compressed and initially filled into an empty tank 71 it heats up again in the receiving tank 71. However, since the tanks, especially in a motor vehicle 70, are only approved up to a temperature of approximately +80° C. this heating-up has to be largely reduced or prevented. For this reason, the hydrogen dispensed by the hydrogen dispensing location 60 via the hydrogen dispensing unit 61 is delivered by being cooled. The consequence of this is that in the fluid-tight connection a temperature in the range from −10° C. to −30° C. is present during the dispensing of the hydrogen.

However, this leads to problems in the measuring precision of the flowmeter 12 since a very large temperature range has to be covered in this case. Hence, a zero drift occurs that is no longer acceptable for a calibration measurement.

Therefore, in accordance with the invention the suggestion is made to actively cool the flowmeter 12. According to the invention, for this purpose a receptacle 15 that is accessible from the outside is provided in the measuring unit 10. In FIG. 1 an external cooling material 30, such as dry ice, is provided in a simplified manner in this receptacle 15. The receiving device 15 is constructed such that it ends in the area of the flowmeter 12 and has a common wall 17 with the flowmeter 12 for example. In this way, a thermal contact is brought about so that the flowmeter 12 can be cooled.

If, for example, dry ice is used as cooling material 30 this offers the advantage that it can be procured relatively easily and is cost-efficient. Since it is inert it can also be used in the explosion-protected area of a fueling station.

The data determined during such a measurement, on the one hand those of the control and evaluation unit 19 relating to the throughflow and on the other hand the optionally provided data of the temperature sensor 13 and the pressure sensor 14 are passed on to the display unit 20 and stored there in a data logger 22 as well as displayed on a corresponding measurement display 24.

To enable communication between the hydrogen dispensing unit 61 and the receiving tank 71 provision is made in accordance with the standards for an infrared connection which can be of cable-based design. Via this infrared connection information on the refueling state and the like are exchanged between the receiving tank 71 and the hydrogen dispensing unit 61.

To allow for continuation of this communication two options are suggested in accordance with the invention. Both of these are illustrated in FIG. 2, yet normally both options are not used at the same time.

On the one hand the infrared connection can be led past the measuring system 1, as shown by way of the infrared connection 41. In this case, the measuring system 1 does not obtain any information from the infrared channel. On the other hand, the measuring system 1 can be actively interposed. To this end, two infrared connections 42 are provided that are also drawn in FIG. 2.

This has the effect that the information runs through the measuring unit 10 and can perhaps be read there or can also be additionally evaluated.

The advantage of the system according to the invention resides in the fact that through this a high-precision measurement can be carried out which does not require considerably more time than a standard fueling process.

According to the law on measures and calibration at least two to four fueling processes are provided which can be readily carried out in the system according to the invention just as a regular fueling process at the fueling station. This results in a significant time advantage as compared to known systems.

Hence, with the measuring system according to the invention and the method according to the invention it is possible to carry out a calibration test measurement of a hydrogen fueling station in an efficient and rapid way.

1. A measuring system for determining a dispensed amount of hydrogen of a hydrogen dispensing location, in particular a hydrogen fueling station, from a hydrogen dispensing unit in form of a filling point present there to a receiving tank,
the measuring system comprising
a measuring unit,
wherein
the measuring unit including a flowmeter which can be arranged between the hydrogen dispensing unit in form of a filling point and the receiving tank,
the measuring system is designed to establish a fluid-tight connection between the hydrogen dispensing unit in form of a filling point and the receiving tank whereby a fluid-tight connection is established from the hydrogen-dispensing unit in the form of a filling point to the measuring unit and a fluid-tight connection can be is established from the measuring unit to the receiving tank,
the measuring unit is designed to lead hydrogen dispensed by the hydrogen dispensing unit in form of a filling point through the flowmeter of the measuring unit to the receiving tank and
the flowmeter has is actively cooled in that the flowmeter has an active cooling system which is designed to cool the flowmeter before the start of the transfer of the hydrogen in such a way that there is essentially no change in the temperature in the flowmeter during the transfer.

2. The measuring system according to claim 1, wherein
the active cooling system comprises an external cooling system.

3. The measuring system according to claim 1, wherein
the active cooling system is realized by means of an external cooling material, in particular dry ice.

4. The measuring system according to claim 1, wherein
a receiving device with thermal contact to the flowmeter is designed in the measuring unit.

5. The measuring system according to claim 4, wherein
the receiving device is designed as a hollow space accessible from the outside.

6. The measuring system according to claim 4, wherein
a wall of the receiving device is designed by way of a body of the flowmeter.

7. The measuring system according to claim 1,
wherein
the flowmeter is constructed as a Coriolis flowmeter, an ultrasonic flowmeter or a flowmeter using critical nozzles.

8. The measuring system according to claims 1,
wherein
a connection for transmitting cable-based bidirectional infrared signals between the hydrogen dispensing unit and the receiving tank is provided.

9. The measuring system according to claim 8, wherein
the connection is guided around the measuring unit.

10. The measuring system according to claim 8, wherein
the connection is guided through the measuring unit.

11. The measuring system according to claim 1,
wherein
the measuring unit has the flowmeter and a control and evaluation unit.

12. The measuring system according to claim 1 wherein
a display unit is provided which has at least a data logger and a measurement display and
is that the display unit is in communication connection with the measuring unit.

13. A method for determining the dispensed amount of hydrogen of a hydrogen dispensing location, in particular a hydrogen fueling station, with a hydrogen dispensing unit in form of a filling point to a receiving tank, the method comprising:
using a measuring system according claims,
wherein a fluid-tight connection is established between the hydrogen dispensing unit in form of a filling point and the measuring unit as well as between the measuring unit and the receiving tank,
wherein via the fluid-tight connection hydrogen is transferred from the hydrogen dispensing unit in form of a filling point via the flowmeter of the measuring unit of the measuring system to the receiving tank,
wherein the throughflow of hydrogen through the flowmeter is determined during the dispensing of the hydrogen from the hydrogen dispensing unit to the receiving tank and
wherein the flowmeter is actively cooled before the beginning of the transfer of the hydrogen from the hydrogen dispensing unit to the receiving tank such that substantially no change in temperature occurs in the flowmeter during the transfer.

14. The method according to claim 13, wherein
the flowmeter is cooled by means of cooling material, in particular dry ice, introduced into the receiving space.
